(19) United States
(12) Patent Application Publication
(10) Pub. No.: US 2025/0356579 A1
(43) Pub. Date: Nov. 20, 2025

(54) VIEW-CONDITIONED DIFFUSION FOR REAL-WORLD VEHICLE GAUSSIAN SPLATTING

(71) Applicant: NEC Laboratories America, Inc., Princeton, NJ (US)

(72) Inventors: Bingbing Zhuang, Santa Clara, CA (US); Ziyu Jiang, Sunnyvale, CA (US); Manmohan Chandraker, Santa Clara, CA (US); Chuang Lin, Melbourne (AU); Shanlin Sun, Irvine, CA (US)

(21) Appl. No.: 19/206,267

(22) Filed: May 13, 2025

Related U.S. Application Data
(60) Provisional application No. 63/647,113, filed on May 14, 2024.
(60) Provisional application No. 63/649,589, filed on May 20, 2024.

(51) Int. Cl. G06T 15/20; G06T 15/40; G06T 19/20; G06V 10/774

(52) U.S. Cl. CPC G06T 15/20; G06T 15/40; G06T 19/20; G06T 2210/22; G06T 2210/41; G06T 2219/2016; G06V 10/774

(57) ABSTRACT

Systems and methods for view-conditioned diffusion for real-world vehicle gaussian splatting. A single perspective image can be transformed using image transformation techniques to generate a training dataset that addresses a domain gap between synthetic data and real-world data in a traffic scene. A pre-trained diffusion model can be finetuned with the training dataset to obtain a fine-tuned diffusion model. Perspective-aware images having different perspective views of an entity from the single perspective image can be generated using the fine-tuned diffusion model. A large generative model (LGM) can be trained using the perspective-aware images to generate a gaussian splatting model for the entity. View-conditioned simulations from the single perspective image can be generated by using the gaussian splatting model for downstream tasks.

### RELATED APPLICATION INFORMATION

This application claims priority to U.S. Provisional App. No. 63/647,113, filed on May 14, 2024; and to U.S. Provisional App. No. 63/649,589, filed on May 20, 2024; incorporated herein by reference in their entirety.

### BACKGROUND

### Technical Field

The present invention relates to training machine learning models and more particularly to view-conditioned diffusion for real-world vehicle gaussian splatting.

### Description of the Related Art

Autonomous driving learning capability of autonomous vehicles relies on the quality of training datasets. To capture real-world scenarios and behaviors, training with real-world data is preferred. However, obtaining real-world data is cost intensive and impractical for immediate use. Synthetic data from datasets can be used, but it lacks the semantic information that describes real-world behaviors. Due to this domain gap, training autonomous vehicles for autonomous driving is still a developing field.

### SUMMARY

According to an aspect of the present invention, a computer-implemented method is provided, including, transforming a single perspective image using image transformation techniques to generate a training dataset that addresses a domain gap between synthetic data and real-world data in a traffic scene, finetuning a pre-trained diffusion model with the training dataset to obtain a fine-tuned diffusion model, generating perspective-aware images having different perspective views of an entity from the single perspective image using the fine-tuned diffusion model, training a large generative model (LGM) using the perspective-aware images to generate a gaussian splatting model for the entity, and generating view-conditioned simulations from the single perspective image by using the gaussian splatting model for downstream tasks.

According to another aspect of the present invention, a system is provided, including, a memory device, one or more processor devices operatively coupled with the memory device to perform operations having, transforming a single perspective image using image transformation techniques to generate a training dataset that addresses a domain gap between synthetic data and real-world data in a traffic scene, finetuning a pre-trained diffusion model with the training dataset to obtain a fine-tuned diffusion model, generating perspective-aware images having different perspective views of an entity from the single perspective image using the fine-tuned diffusion model, training a large generative model (LGM) using the perspective-aware images to generate a gaussian splatting model for the entity, and generating view-conditioned simulations from the single perspective image by using the gaussian splatting model for downstream tasks.

According to yet another aspect of the present invention, a non-transitory computer program product is provided including a computer-readable storage medium having a program code, wherein the program code executed on a computer causes the computer to perform operations including, transforming a single perspective image using image transformation techniques to generate a training dataset that addresses a domain gap between synthetic data and real-world data in a traffic scene, finetuning a pre-trained diffusion model with the training dataset to obtain a fine-tuned diffusion model, generating perspective-aware images having different perspective views of an entity from the single perspective image using the fine-tuned diffusion model, training a large generative model (LGM) using the perspective-aware images to generate a gaussian splatting model for the entity, and generating view-conditioned simulations from the single perspective image by using the gaussian splatting model for downstream tasks.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram showing a high-level overview of a computer-implemented method for view-conditioned diffusion for real-world vehicle gaussian splatting, in accordance with an embodiment of the present invention;

FIG. 2 is a block diagram showing virtual rotation of a camera through rotational homography, in accordance with an embodiment of the present embodiments;

FIG. 3 is a block diagram showing a process of generating occlusion mask and different perspective view of a single perspective image, in accordance with an embodiment of the present invention.

FIG. 4 is a block diagram showing a system implementing practical applications for view-conditioned diffusion for real-world vehicle gaussian splatting, in accordance with an embodiment of the present invention;

FIG. 5 is a block diagram showing hardware and software components of a computing system implementing view-conditioned diffusion for real-world vehicle gaussian splatting, in accordance with an embodiment of the present invention;

FIG. 6 is a block diagram showing a computing device implementing view-conditioned diffusion for real-world vehicle gaussian splatting, in accordance with an embodiment of the present invention; and

FIG. 7 is a block diagram showing a structure of deep neural networks view-conditioned diffusion for real-world vehicle gaussian splatting, in accordance with an embodiment of the present invention

### DETAILED DESCRIPTION OF PREFERRED EMBODIMENTS

In accordance with embodiments of the present invention, systems and methods are provided for view-conditioned diffusion for real-world vehicle gaussian splatting.

In an embodiment, a single perspective image can be transformed using image transformation techniques to generate a training dataset that addresses a domain gap between synthetic data and real-world data in a traffic scene. A pre-trained diffusion model can be finetuned with the training dataset to obtain a fine-tuned diffusion model. Perspective-aware images having different perspective views of an entity from the single perspective image can be generated using the fine-tuned diffusion model. A large generative model (LGM) can be trained using the perspective-aware images to generate a gaussian splatting model for the entity. View-conditioned simulations from the single perspective image can be generated by using the gaussian splatting model for downstream tasks.

Modern autonomous driving systems rely on data-driven deep learning frameworks to learn autonomous driving capability. The machine learning framework is trained and verified on a large amount of diverse data that covers various scenarios in the real-world. However, collecting such data with high degree of diversity is expensive and not scalable, which resulted in an emerging trend of using simulations. Traditional procedure-based graphic pipelines for simulations are relatively mature, but require expensive manual efforts from artist experts to achieve high degree of photorealism.

Neural rendering and generative AI techniques can be used for generating simulations for autonomous driving. However, such techniques still have issues in acquiring object assets from real-world data. For example, there is difficulty on ensuring a seamless combination of the object assets with simulated scenes to create a traffic scene.

To perform such combination, three dimensional (3D) reconstructions of a vehicle using images from onboard cameras can be performed. Gaussian splatting is a 3D reconstructing technique that offers real-time radiance field rendering by creating multiple gaussian splats (translucent ellipsoidal blobs) that blend together to create a 3D model when viewed from different angles. However, the limited viewpoint coverage of the onboard cameras also limits the 3D reconstructions into a single perspective view 3D reconstruction. Due to the ill-posed nature of single-view 3D reconstruction, the performance of existing single-view 3D reconstruction methods are still unsatisfactory.

Alternatively, generative diffusion models are capable of generating 3D reconstructions from two dimensional (2D) images. However, generative diffusion methods that perform 3D reconstructions from 2D images still have issues with consistency due to the lack of a 3D representation. And because such methods only train using synthetic datasets, their reconstruction performance on real-world entities such as vehicles is poor due to the domain gap between synthetic dataset and real-world data. The domain gap can be caused by the difference in statistical properties and distributions between the two different datasets which can cause a difference in variability, noise, and dependencies between entities within the datasets.

To address these issues, the present embodiments leverage generative diffusion models and large 3D reconstruction models to generate a training dataset that bridges the domain gap between synthetic data and real data. The training dataset can be utilized to train a large generative model to generate a gaussian splatting model for each entity detected in a single perspective image. The gaussian splatting models can be utilized to generate view-conditioned simulations of the single perspective image for performing downstream tasks.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

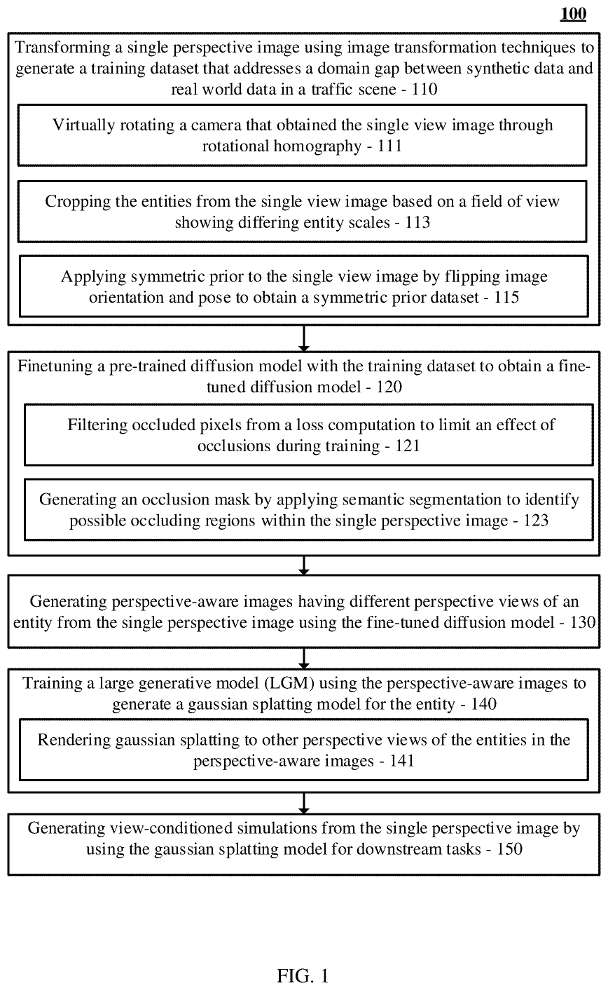

Referring now in detail to the figures in which like numerals represent the same or similar elements and initially to FIG. 1, a flow diagram showing a high-level overview of a computer-implemented method for view-conditioned diffusion for real-world vehicle gaussian splatting, in accordance with an embodiment of the present invention.

In an embodiment, a single perspective image can be transformed using image transformation techniques to generate a training dataset that addresses a domain gap between synthetic data and real-world data in a traffic scene. A pre-trained diffusion model can be finetuned with the training dataset to obtain a fine-tuned diffusion model. Perspective-aware images having different perspective views of an entity from the single perspective image can be generated using the fine-tuned diffusion model. A large generative model (LGM) can be trained using the perspective-aware images to generate a gaussian splatting model for the entity. View-conditioned simulations from the single perspective image can be generated by using the gaussian splatting model for downstream tasks.

In block 110, a single perspective image can be transformed using image transformation techniques to generate a training dataset that addresses a domain gap between synthetic data and real-world data in a traffic scene.

The single perspective image can be obtained by a camera. For example, a camera mounted on an autonomous vehicle can capture an image of a traffic scene containing vehicles. A single camera can capture an image from one perspective view.

The training dataset can include synthetic dataset tailored for a domain such as Objaverse™ for a diverse array of 3D objects.

Synthetic dataset images are rendered with the camera viewing direction pointing to object center, at distances varying in a small range, with a predefined field of view. As a result, the rendered objects remain largely on the image center with similar spatial extent. This is not the case for real data. The camera can capture multiple surrounding vehicles that fall into its field of view, but the camera viewing direction does not pass through any object center. Thus, objects are not on the image center in real-world images.

As a cloud sourced dataset from internet, the 3D models in synthetic datasets are aligned only in elevation (approximately along gravity direction), but not in azimuth, which is randomly specified by model creators without a common reference. Hence, 3D reconstruction models trained in synthetic datasets can only rely on the relative pose to the input view as the pose condition, instead of the more informative absolute poses which can characterize both the input and output view pose individually. Real-world autonomous driving datasets, (e.g. Waymo™, etc.), can have human annotated object 3D boxes, yielding absolute poses. However, adopting absolute pose introduces a tradeoff as it compromises the generic pose conditioning prior learned for relative pose. As a result, the model has to learn from scratch by itself using the real data. Absolute pose conditioning can work reasonably well under small to medium viewpoint changes, but the strong prior on relative pose conditioning can result in more benefits in large viewpoint changes.

To account for the domain gap between synthetic data and real-world data, image transformation techniques can be applied to the single perspective image. The image transformation techniques can include virtual rotation, entity cropping, applying symmetric prior, etc.

In block 111, a camera that obtained the single perspective image can be virtually rotated through rotational homography.

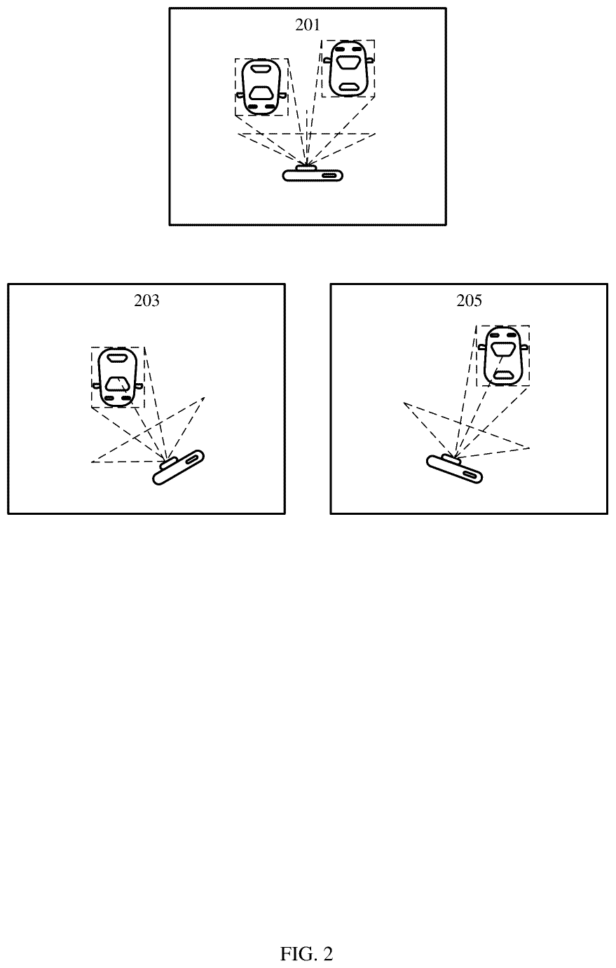

The surrounding vehicles from the camera may spatially appear in a large range of distances (e.g., two meters to a hundred meters) to the camera, causing a large variation in the extent of vehicles on the image plane. To address such discrepancy, objects can be moved to an image center in a geometrically meaningful manner by virtually rotating the camera through rotational homography such that the camera's viewing direction pass through the object center. This is shown in more detail in FIG. 2.

Referring now to FIG. 2, a block diagram showing virtual rotation of a camera through rotational homography, in accordance with an embodiment of the present embodiments.

The camera pose distribution in real data deviates largely from the canonical pose space in the training data. On-board cameras can capture multiple objects in the scene simultaneously, without the optical axis passing though object centers (represented as solid line) as in orbital camera poses, as illustrated in block 201. In order to inherit the strong pose conditioning prior from the pretrained large models in a geometrically principled manner, the present embodiments can transform the camera pose into an orbital one as a canonical pose space. As illustrated in blocks 203 and 205 for each object in the scene, the present embodiments can virtually rotate the camera to be congruent with an orbital camera pose. With the camera center unaltered, this step is scene-independent and can be warped precisely with a rotational homography. This step creates object-centric images as in the training data and allows them to depict the camera pose in the format of (α, θ, z) in 203 and (α, −θ, z) in 205, where α as the elevation, θ as the azimuth, and z as the distance.

In block 113, the entities can be cropped from the single perspective image based on a field of view showing differing entity scales.

The entities can be objects detected within the single perspective image such as vehicles for a traffic scene.

After the virtual rotation, the present embodiments can explore several strategies in choosing a field of view to crop the object patch, with a view to handling the varying object scale in real images. In an embodiment, a fixed field of view can be used as generated in the synthetic data from the training dataset. This leaves the object scale variation as is in the cropped object patch. In this embodiment, the pretrained diffusion model is adept at learning robust representations across different scales due to the pretraining of the image encoder of the pretrained diffusion model. This can lead to better accuracy and efficiency in generating different perspective views of monitored entities. In another embodiment, varying focal lengths can be used by determining the field of view in an adaptive manner to have similar object scale across all images. To do so, an object 2D bounding box can be expanded by a fixed ratio followed by a squared cropping and resizing. With a fixed image size (e.g., 512×512), the varying field of view can effectively translate varying focal lengths in the resultant images.

In block 115, symmetric prior can be applied to the single perspective image by flipping image orientation and pose to obtain a symmetric prior dataset.

To apply symmetric prior on an entity in the single perspective image, the entity image can be flipped from left to right. The camera pose can also be flipped accordingly in a manner consistent with the image. Together with the original image, we feed such a pair of training data for backpropagation.

The symmetric nature of the vehicle category serves as a free prior to leverage. Under this assumption, the symmetric counterpart can be obtained for an object instance by horizontally flipping the image and setting the camera pose as (α, −θ, z) as illustrated in FIG. 2. The symmetric prior can be enforced during training in order to achieve pose consistency in diffusion image generation. In an embodiment, the symmetric prior can be enforced with weak guidance as a standard data augmentation, where each image instance and its camera pose are horizontally flipped with a 50% probability before feeding into network. In another embodiment, the symmetric prior can be enforced with strong guidance by training the network with pairs of symmetric images in each batch, where each image instance is fed along with its symmetric one as a pair to the network. By enforcing with strong guidance, significantly superior image generation quality and pose consistency can be obtained. This phenomenon can be explained by the limited viewpoint variations in real driving data and the symmetric flipping largely expanding the span of pose variations.

In block 120, a diffusion model can be finetuned with the training dataset to obtain a fine-tuned diffusion model.

The diffusion model can be an image processing model that was trained to process the training dataset to generate 3D models. The diffusion model can utilize pretrained deep learning diffusion models such as Free3D, StableDiffusion™, etc.

The diffusion model can be finetuned using real-world images. The real-world image can be obtained from single perspective images. The diffusion model can be trained with entities identified within the real-world image in its original perspective view and other predicted perspective views of the same entities. The training loss is the per pixel difference between the network prediction of the perspective views of the same entities and ground truth. In an embodiment, the training can be supervised with real-world images having different perspective views as ground truth.

Occlusions can occur due to having a single perspective images which can limit the accuracy of the training. This is addressed by the present embodiments.

In block 121, occluded pixels can be filtered from the loss computation to limit the effect of occlusions during training.

To prevent occlusions from affecting the fine-tuning process, the occluded pixels can be eliminated from the loss computation. An occlusion mask can be generated from a single perspective image to determine the occluded pixels.

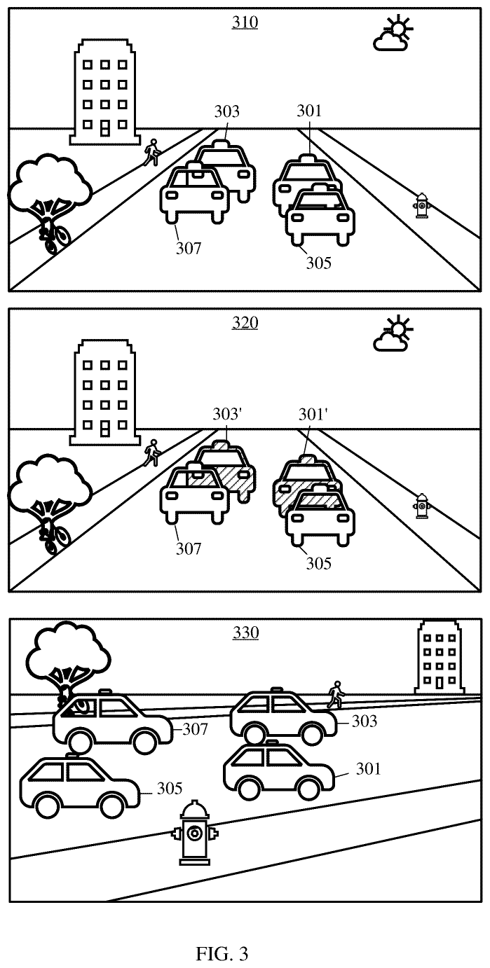

In block 123, an occlusion mask can be generated by applying semantic segmentation to identify possible occluding regions within the single perspective image. In an embodiment, semantic segmentation can be performed on the single perspective image to identify plausible occluding regions and generate an occlusion mask. The plausible occluding regions can include neighboring objects that are likely occluding the object of interest. Additionally, known entities can be deemed as background entities such as sky, road surface, and building. The semantic segmentation process can be performed by a pre-trained image processing model such as AutoRF. This is shown in more detail in FIG. 3.

In another embodiment, the single perspective image can be concatenated with its occlusion mask in the network input with a view that can supply direct occlusion signal.

Referring now to FIG. 3, a block diagram showing a process of generating occlusion mask and different perspective view of a single perspective image, in accordance with an embodiment of the present invention.

Block 310 shows a single perspective image of a traffic scene containing two entities (e.g., vehicles) 301, 303, 305, and 307. The entities can be identified using semantic segmentation using a pre-trained image processing neural network.

Block 320 shows the same single perspective image but with an occlusion mask. Occlusions can also be detected through semantic segmentation, and the detected entities with occluded pixels (e.g., 303′, 301′) can be processed with an occlusion mask (represented by a slanted line fill).

Block 330 shows a different perspective view of the same single perspective image including entities 301, 303, 305, 307 that can be generated by the fine-tuned diffusion model.

The latent diffusion model can apply the denoising and losses in the latent space. However, no exact one-to-one correspondences exists for mapping pixels to the elements in the latent feature map due to the receptive field of networks. To address this, the masking operation in the latent space can be transferred seamlessly to the image space for the image inpainting task of the diffusion model.

Specifically, the encoded source and target view in latent space can be denoted as z^{STC} and z^{trg}, we first downsample the target view occlusion mask m can be downsampled to the same size as z^{trg}, denoted as m_{d}. The standard loss between predicted noise ∈_{θ} and its ground truth ∈ can be updated to:

$$ℒ = 𝔼 [ {\vert M ( ∈ , {m}_{d} ) - M ( {∈}_{θ} ( {z}^{trg} , t , y ) , {m}_{d} ) \vert}_{2}^{2} ]$$

where the network is conditioned on y=(z^{src}, P) with P including both the global and local pose embedding, [symbol] is the expectation of the values, and M(x, m_{d})=x·m_{d}+(1−m_{d}) is used to apply the occlusion mask.

With the above strategies, the pretrained diffusion model can be fine-tuned on real-world autonomous driving data. As a result, the single perspective image input with its camera pose can generate novel views with new camera poses using the fine-tuned diffusion model.

In block 130, perspective-aware images having different perspective views of an entity from the single perspective image can be generated using the fine-tuned diffusion model.

The fine-tuned diffusion model can generate perspective-aware images of each entity at equally spaced viewing angle to cover the entire vehicle from different perspective views. In an embodiment, the fine-tuned diffusion model can generate at least four perspective-aware images to cover at least four perspective views (e.g., top, bottom, left, right perspective views) of an entity within the single perspective image. The fine-tuned diffusion model includes the generative capability and photorealism from the pre-training of the diffusion model. The fine-tuned diffusion model also includes pose-condition training on the synthetic dataset of the training data which combines real-world image processing during the fine-tuning process. The fine-tuned diffusion model can utilize a multi-view generation diffusion model (e.g., Free3D™, etc.)

In block 140, a large generative model (LGM) can be trained using the perspective-aware images to generate a gaussian splatting model for the entity.

The large generative model can be trained using the perspective-aware images by rendering gaussian splatting onto other views of the same object in the sequence and enforcing per-pixel loss function. The occlusions are accounted similarly as described in blocks 121 to 123. In an embodiment, the large generative model can utilize neural network frameworks for image processing such as convolutional neural networks, etc. In another embodiment, the large generative model can utilize available generation models such as StableDiffusion™, GPT™, etc.

The large generative model can be trained by minimizing a loss function:

$$ℒ = {\sum }_{x , y} M ( x , y ) {\vert {I}_{g t} ( x , y ) - \hat{I} ( x , y ) \vert}_{2}^{2} ,$$

where the error over every pixel location (x, y) in the image can be accumulated; I_{gt}(x, y) is the true color (or intensity) at pixel (x, y) in the target image, Î(x, y) is the color our model produced when rendering the scene (via Gaussian splatting) at that same pixel, and M(x, y) is the occlusion mask.

In block 150, view-conditioned simulations from the single perspective image can be generated by using the gaussian splatting model for downstream tasks.

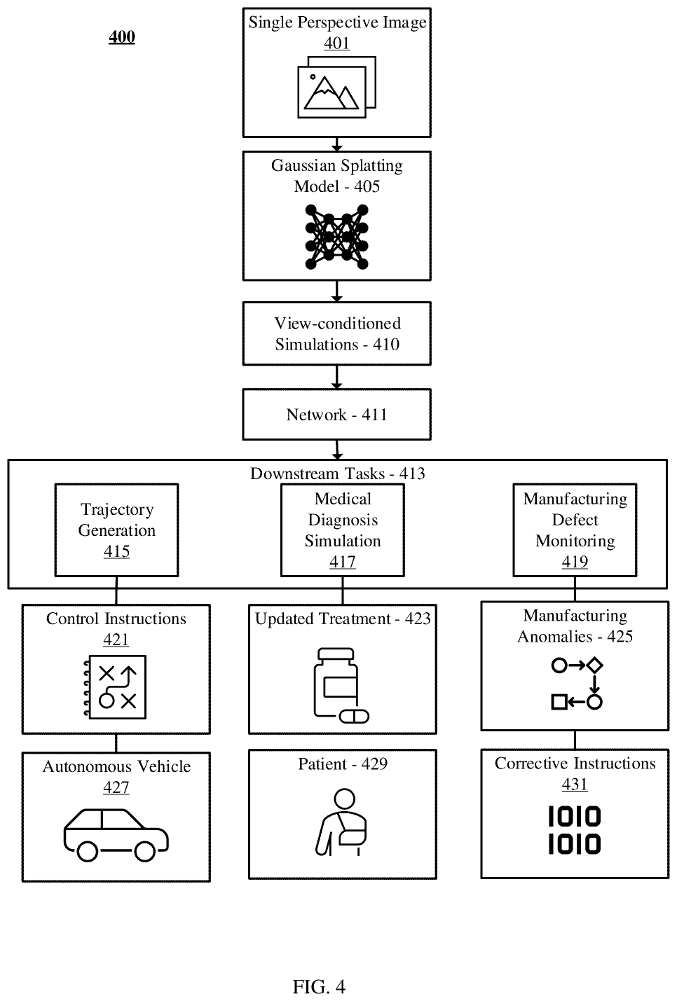

To generate the view-conditioned simulations by utilizing the LGM based on the gaussian splatting model. The view-conditioned simulations generated from the single view of an input image can include scenarios that relate to a monitored entity within that input image that takes advantage of the additional depth provided by gaussian splatting. The three-dimensional assets included in the view-conditioned simulations can be utilized in any simulation framework (e.g. CARLA™). The view-conditioned simulations can be utilized for various downstream tasks. This is shown in more detail in FIG. 4.

Referring now to FIG. 4, a block diagram showing a system implementing practical applications for view-conditioned diffusion for real-world vehicle gaussian splatting, in accordance with an embodiment of the present invention.

In system 400, a single perspective image 401 can be processed by the trained gaussian splatting model 405 to generate view-conditioned simulations 410. The view-conditioned simulations 410 can be transmitted to a network 411 to be distributed to end-user computing systems to perform downstream tasks 413 such as trajectory generation 415, medical diagnosis simulation 417, and manufacturing defect monitoring 419. As described, the present embodiments are not limited to autonomous driving systems and traffic scene reconstructions, and can be applied to other fields such as anomaly detection, medical treatment generation, etc.

In trajectory generation 415, the single perspective image 401 can be obtained by sensors on autonomous vehicle 427 that can connect to network 411. The single perspective image 401 can include a traffic scene in the real-world that includes other neighboring vehicles, traffic signs, intersections, etc. The view-conditioned simulations 410 can include predictions of vehicle behavior of a monitored vehicle (e.g., one of the neighboring vehicles, or the autonomous vehicle 427). The vehicle behavior can include changes in speed, direction, etc. The view-conditioned simulations 410 can be displayed on an output display within the autonomous vehicle 427 or through a connected device (e.g., smartphone, laptop, tablet, etc.). The autonomous vehicle 427 can generate control instructions 421 according to a trajectory generated that considers the view-conditioned simulations 410. The control instructions 421 can include speeding up, changing direction, slowing down, through the traffic scene. The control instructions 421 can be processed by the driving control system (e.g., advanced driving assistance system, etc.) of the autonomous vehicle 427.

In medical diagnosis simulation 417, a single perspective image 401 can include medical readings of a patient 429 (e.g., x-ray images, CAT scan images, real-world image of patient, etc.). The view-conditioned simulations 410 can include predictions of how a monitored portion (e.g., diseased part of the patient 429) of the input image can progress over time. Based on the view-conditioned simulations 410, a decision-making entity can generate an updated treatment 423 for the patient 429. For example, a patient 429 can have a rash on their arm and was prescribed anti-fungal ointment to cure it. The view-conditioned simulations 410 can include how the rash would get smaller (or no change, or worsens) after proper administering of the anti-fungal ointment on the rash. The decision-making entity can update the dosage or the anti-fungal ointment based on the view-conditioned simulations 410 and the patient history.

In manufacturing defect monitoring 419, a single perspective image 401 of a monitored entity (e.g., manufacturing robot arm, the widgets being manufactured, computer systems, etc.) within the manufacturing process can be obtained and processed. The view-conditioned simulations 410 can include predictions on how the monitored entity progresses based on obtained system conditions (e.g., temperature, humidity, network bandwidth, etc.). Additionally, the view conditioned simulations 410 can be utilized to detect manufacturing anomalies 425 based on normal conditions of the system. Corrective instructions 431 can be generated to respond to the detected manufacturing anomalies 425 based on the view-conditioned simulations 410. For example, a robotic arm is tasked to weld door hinges on a manufactured vehicle. The robotic arm's temperature can be monitored. Once the robotic arm's temperature goes over the normal threshold number, the robotic arm can be cooled down by using the corrective instructions 431 which can include instructions to shut it off, slow down, etc.

Other practical applications are contemplated.

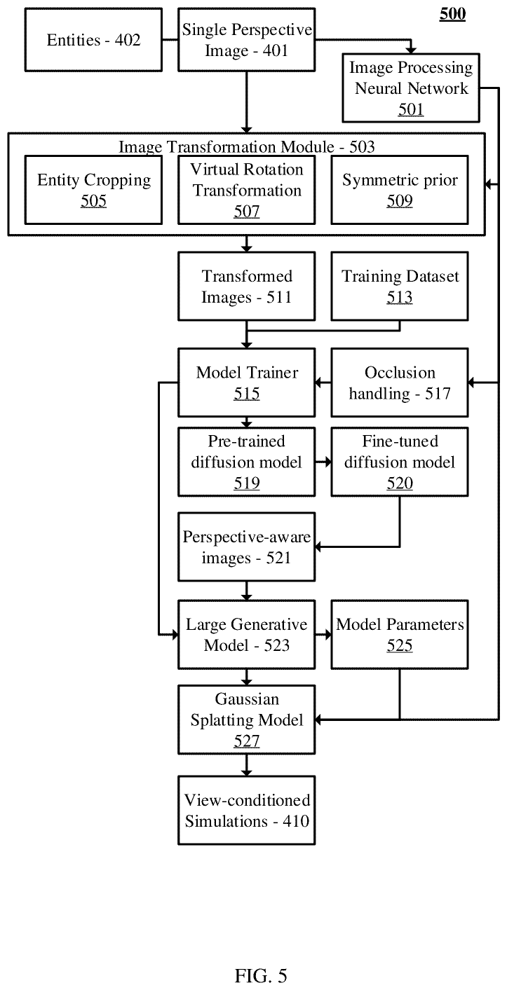

Referring now to FIG. 5, a block diagram showing hardware and software components of a computing system implementing view-conditioned diffusion for real-world vehicle gaussian splatting, in accordance with an embodiment of the present invention.

In system 500, a single perspective image 401 can be processed by an image transformation module 503 to generate transformed images 511. The single perspective image 401 can include entities 402. The image transformation module 503 can perform operations including entity cropping 505, virtual rotation transformation 507, and applying symmetric prior 509. The image transformation model 503 can utilize image processing neural network 501.

The transformed images 511 can be utilized with a training dataset 513 by a model trainer 515 to fine-tune a pre-trained diffusion model 519 to obtain a fine-tuned diffusion model 520. The model trainer 515 can also perform occlusion handling 517 to generate an occlusion mask based on the detected entities through semantic segmentation by using the image processing neural network 501. Occlusion handling 517 can be performed to limit the effect of occlusions to the training and learning of the pre-trained diffusion model 519 of the varying camera poses and corresponding perspective views of the entities.

The fine-tuned diffusion model 520 can be utilized to generate perspective-aware images 521 from the single perspective image 401. The perspective-aware images 521 can be utilized to train a large generative model 523 to generate a gaussian splatting model 527 by predicting model parameters 525 for the gaussian splatting model 527 for entities 402 of the single perspective image 401. The gaussian splatting model 527 can be utilized to generate view-conditioned simulations 410 with the large generative model 523. In another embodiment, the image processing neural network 501 can be utilized with the gaussian splatting model 527 to generate view-conditioned simulations 410.

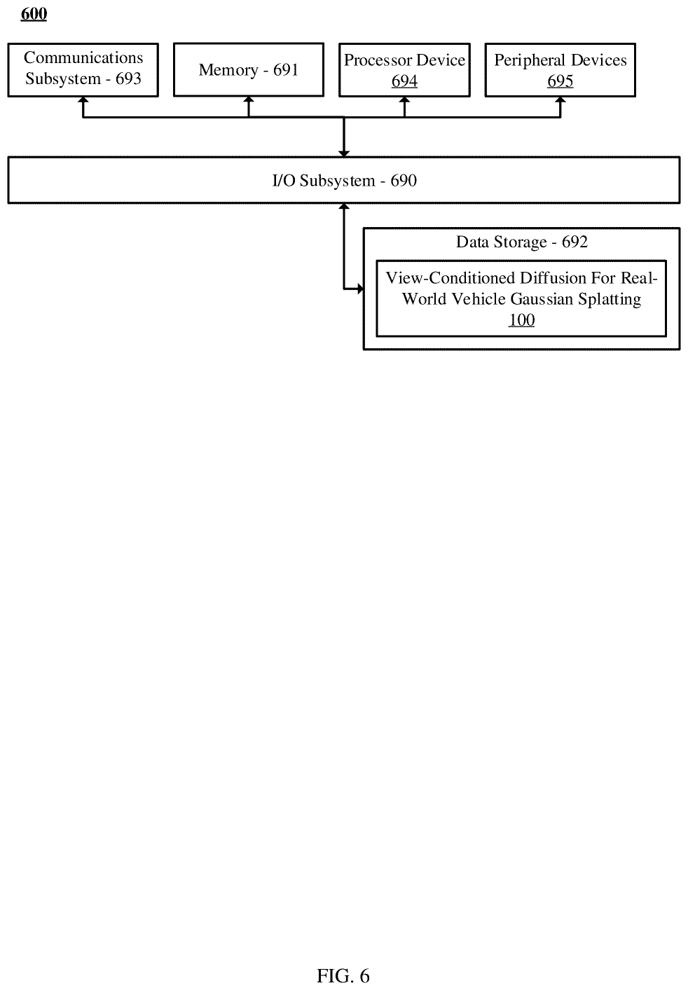

Referring now to FIG. 6, a block diagram showing a computing device implementing view-conditioned diffusion for real-world vehicle gaussian splatting, in accordance with an embodiment of the present invention.

The computing device 600 illustratively includes the processor device 694, an input/output (I/O) subsystem 690, a memory 691, a data storage device 692, and a communication subsystem 693, and/or other components and devices commonly found in a server or similar computing device. The computing device 600 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 691, or portions thereof, may be incorporated in the processor device 694 in some embodiments.

The processor device 694 may be embodied as any type of processor capable of performing the functions described herein. The processor device 694 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 691 may be embodied as any type of volatile or non-volatile memory or data storage capable of performing the functions described herein. In operation, the memory 691 may store various data and software employed during operation of the computing device 600, such as operating systems, applications, programs, libraries, and drivers. The memory 691 is communicatively coupled to the processor device 694 via the I/O subsystem 690, which may be embodied as circuitry and/or components to facilitate input/output operations with the processor device 694, the memory 691, and other components of the computing device 600. For example, the I/O subsystem 690 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 690 may form a portion of a system-on-a-chip (SOC) and be incorporated, along with the processor device 694, the memory 691, and other components of the computing device 600, on a single integrated circuit chip.

The data storage device 692 may be embodied as any type of device or devices configured for short-term or long-term storage of data such as, for example, memory devices and circuits, memory cards, hard disk drives, solid state drives, or other data storage devices. The data storage device 692 can store program code for view-conditioned diffusion for real-world vehicle gaussian splatting 100. Any or all of these program code blocks may be included in a given computing system.

The communication subsystem 693 of the computing device 600 may be embodied as any network interface controller or other communication circuit, device, or collection thereof, capable of enabling communications between the computing device 600 and other remote devices over a network. The communication subsystem 693 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 600 may also include one or more peripheral devices 695. The peripheral devices 695 may include any number of additional input/output devices, interface devices, and/or other peripheral devices. For example, in some embodiments, the peripheral devices 695 may include a display, touch screen, graphics circuitry, keyboard, mouse, speaker system, microphone, network interface, and/or other input/output devices, interface devices, GPS, camera, and/or other peripheral devices.

Of course, the computing device 600 may also include other elements (not shown), as readily contemplated by one of skill in the art, as well as omit certain elements. For example, various other sensors, input devices, and/or output devices can be included in computing device 600, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 600 are readily contemplated by one of ordinary skill in the art given the teachings of the present invention provided herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

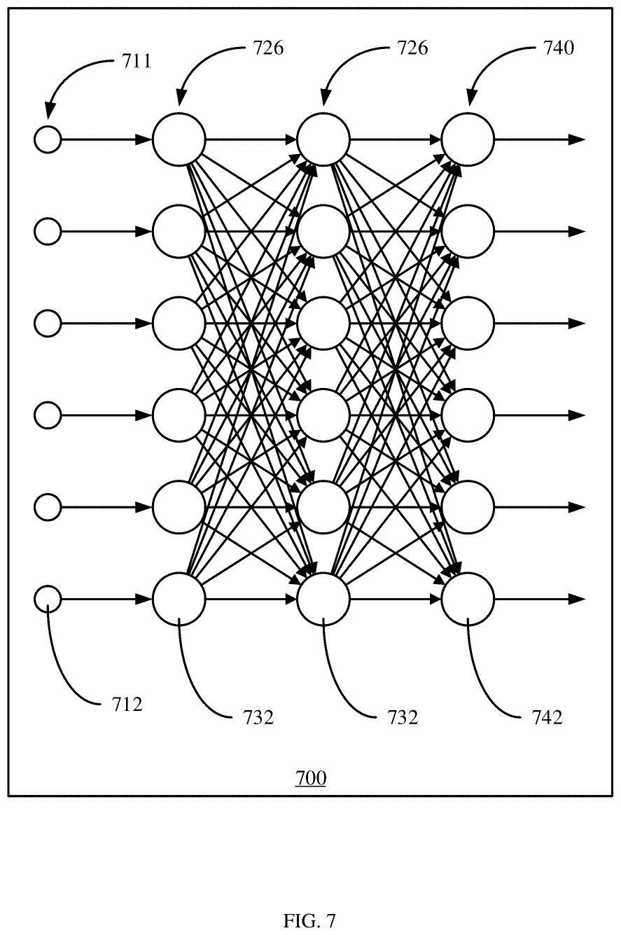

Referring now to FIG. 7, a block diagram showing a structure of deep neural networks view-conditioned diffusion for real-world vehicle gaussian splatting, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 700, such as a multilayer perceptron, can have an input layer 711 of source neurons 712, one or more computation layer(s) 726 having one or more computation neurons 732, and an output layer 740, where there is a single output neuron 742 for each possible category into which the input example could be classified. An input layer 711 can have a number of source neurons 712 equal to the number of data values 712 in the input data 711. The computation neurons 732 in the computation layer(s) 726 can also be referred to as hidden layers, because they are between the source neurons 712 and output neuron(s) 742 and are not directly observed. Each neuron 732, 742 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

Training a deep neural network can involve two phases, a forward phase where the weights of each neuron are fixed and the input propagates through the network, and a backwards phase where an error value is propagated backwards through the network and weight values are updated. The computation neurons 732 in the one or more computation (hidden) layer(s) 726 perform a nonlinear transformation on the input data 712 that generates a feature space. The classes or categories may be more easily separated in the feature space than in the original data space.

In an embodiment, the computation layers 726 of the large generative model 523 can be employed to learn the relationships between the perspective-aware images 521 to predict model parameters 525 of the gaussian splatting model 527. In an embodiment, the computation layers 726 of the large generative model 523 can be employed to learn the relationships between the perspective-aware images 521, model parameters 525 of the gaussian splatting model 527, and the single perspective image 401 to generate view-conditioned simulations 410. In an embodiment, the computation layers 726 of the image processing neural network 501 can be employed to learn the relationships between the perspective-aware images 521, model parameters 525 of the gaussian splatting model 527, and the single perspective image 401 to generate view-conditioned simulations 410.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method, comprising:
transforming a single perspective image using image transformation techniques to generate a training dataset that addresses a domain gap between synthetic data and real-world data in a traffic scene;
finetuning a pre-trained diffusion model with the training dataset to obtain a fine-tuned diffusion model;
generating perspective-aware images having different perspective views of an entity from the single perspective image using the fine-tuned diffusion model;
training a large generative model (LGM) using the perspective-aware images to generate a gaussian splatting model for the entity; and
generating view-conditioned simulations from the single perspective image by using the gaussian splatting model for downstream tasks.

2. The computer-implemented method of claim 1, wherein transforming the single perspective image further comprises virtually rotating a camera that obtained the single perspective image through rotational homography.

3. The computer-implemented method of claim 1, wherein transforming the single perspective image further comprises cropping the entities from the single perspective image based on a field of view showing differing entity scales.

4. The computer-implemented method of claim 1, wherein transforming the single perspective image further comprises applying symmetric prior to the single perspective image by flipping image orientation and pose to obtain a symmetric prior dataset.

5. The computer-implemented method of claim 1, wherein finetuning the diffusion model further comprises filtering occluded pixels from a loss computation to limit an effect of occlusions during training.

6. The computer-implemented method of claim 5, wherein finetuning the diffusion model further comprises generating an occlusion mask by applying semantic segmentation to identify possible occluding regions within the single perspective image.

7. The computer-implemented method of claim 1, wherein training the LGM further comprises rendering gaussian splatting to other perspective views of the entities in the perspective-aware images.

8. The computer-implemented method of claim 1, wherein the downstream tasks include generating control instructions for controlling an autonomous vehicle based on view-conditioned simulations of a traffic scene.

9. The computer-implemented method of claim 1, wherein the downstream tasks include generating an updated medical treatment of a patient to be administered by a decision-making entity based on view-conditioned simulations of a progression of a monitored portion of the patient.

10. A system, comprising:
a memory device;
one or more processor devices operatively coupled with the memory device to perform operations including:
transforming a single perspective image using image transformation techniques to generate a training dataset that addresses a domain gap between synthetic data and real-world data in a traffic scene;
finetuning a pre-trained diffusion model with the training dataset to obtain a fine-tuned diffusion model;
generating perspective-aware images having different perspective views of an entity from the single perspective image using the fine-tuned diffusion model;
training a large generative model (LGM) using the perspective-aware images to generate a gaussian splatting model for the entity; and
generating view-conditioned simulations from the single perspective image by using the gaussian splatting model for downstream tasks.

11. The system of claim 10, wherein transforming the single perspective image further comprises virtually rotating a camera that obtained the single perspective image through rotational homography.

12. The system of claim 10, wherein transforming the single perspective image further comprises cropping the entities from the single perspective image based on a field of view showing differing entity scales.

13. The system of claim 10, wherein transforming the single perspective image further comprises applying symmetric prior to the single perspective image by flipping image orientation and pose to obtain a symmetric prior dataset.

14. The system of claim 10, wherein finetuning the diffusion model further comprises filtering occluded pixels from a loss computation to limit an effect of occlusions during training.

15. The system of claim 14, wherein finetuning the diffusion model further comprises generating an occlusion mask by applying semantic segmentation to identify possible occluding regions within the single perspective image.

16. The system of claim 10, wherein training the LGM further comprises rendering gaussian splatting to other perspective views of the entities in the perspective-aware images.

17. The system of claim 10, wherein the downstream tasks include generating control instructions for controlling an autonomous vehicle based on view-conditioned simulations of a traffic scene.

18. The system of claim 10, wherein the downstream tasks include generating an updated medical treatment of a patient to be administered by a decision-making entity based on view-conditioned simulations of a progression of a monitored portion of the patient.

19. A non-transitory computer program product comprising a computer-readable storage medium including a program code, wherein the program code executed on a computer causes the computer to perform operations including comprising:
transforming a single perspective image using image transformation techniques to generate a training dataset that addresses a domain gap between synthetic data and real-world data in a traffic scene;
finetuning a pre-trained diffusion model with the training dataset to obtain a fine-tuned diffusion model;
generating perspective-aware images having different perspective views of an entity from the single perspective image using the fine-tuned diffusion model;
training a large generative model (LGM) using the perspective-aware images to generate a gaussian splatting model for the entity; and
generating view-conditioned simulations from the single perspective image by using the gaussian splatting model for downstream tasks.

20. The non-transitory computer program product of claim 19, wherein the downstream tasks include generating control instructions for controlling an autonomous vehicle based on view-conditioned simulations of a traffic scene.
